(19) United States
(12) Patent Application Publication
(10) Pub. No.: US 2008/0134893 A1
(43) Pub. Date: Jun. 12, 2008

(54) Particulate filter media

(76) Inventors: Thauming Kuo, Kingsport, TN (US); Ted Calvin Germroth, Kingsport, TN (US); Mark Kevin Vineyard, Blountville, TN (US); Weimin Chen Liang, Kingsport, TN (US)

Correspondence Address: MICHAEL K. CARRIER, EASTMAN CHEMICAL COMPANY, 100 NORTH EASTMAN ROAD, KINGSPORT, TN, 37660-5075, US

(21) Appl. No.: 11/635,988

(22) Filed: Dec. 8, 2006

(51) Int. Cl. B01D 46/30; C08F 118/02; B01D 50/00; B01D 24/00

(52) U.S. Cl. 95/274; 526/319; 526/317.1; 55/522; 55/385.1

(57) ABSTRACT

Disclosed are particulate filter media comprising a particulate or powdery acetoacetate-functional compound or composition that is effective in removing gaseous aldehydes present in gases such as air. The particulate filter media are capable of reacting with and irreversibly removing airborne aldehydes, such as formaldehyde, acetaldehyde, and acrolein. Also disclosed is a method or process for the removal of an aldehyde from a gas such as air or tobacco smoke by contacting the aldehyde-containing gas with the particulate filter media.

### FIELD OF THE INVENTION

This invention relates to particulate filter media comprising a particulate or powdery acetoacetate-functional compound or composition that is effective in removing gaseous aldehydes present in gases such as air. The particulate filter media are capable of reacting with and irreversibly removing airborne aldehydes, such as formaldehyde, acetaldehyde, and acrolein. The present invention also relates to a process for the removal of an aldehyde from a gas such as air by contacting the aldehyde-containing gas with the particulate filter media. The invention further pertains to novel dry, particulate, acetoacetate-functional addition polymers having a glass transition temperature (Tg) >40° C. that are not film-forming.

### BACKGROUND OF THE INVENTION

Formaldehyde is a common pollutant existing in homes, offices, public building, and other enclosed structures. It is a highly reactive chemical and can cause health problems such as headache, dizziness, nausea, and irritations of eyes, respiratory, and skin. A major source of formaldehyde emissions is building materials such as plywood, particleboard, paneling, laminates, carpet glues, and wallpaper, which employ urea-formaldehyde adhesives. Examples of other sources of formaldehyde pollution are foam insulation materials, paints, and coatings that comprise formaldehyde-based resins. Formaldehyde emissions typically result from the presence of unreacted formaldehyde in the resins or from degradation of the cured resins.

Various types of technologies for the removing airborne formaldehyde are described in the prior art. U.S. Pat. No. 5,352,274 discloses a method of filtering air by utilizing a plurality of corrugated base sheets which are stacked or nestled and which have entrapped carbon dust for adsorption of impurities such as formaldehyde, acetaldehyde, and acrolein. The corrugated structure provides very little pressure drop as the air passes through available channels and large, powerful fans are not necessary to move air therethrough. This technology provides a method to physically adsorb formaldehyde molecules but does not chemically eliminate formaldehyde. U.S. Pat. No. 5,830,414 discloses an air cleaning filter comprising activated carbon fibers in the form of a web which supports at least one kind of chemical reagent selected from the group consisting of (a) an alkali agent selected from a hydroxide or carbonate of an alkali metal, (b) an acidifying agent selected from acid aluminum phosphate or phosphoric acid, and (c) an oxidizing agent composed of active manganese dioxide resulting from an alkali permanganate and an alkali iodate. U.S. Pat. No. 5,830,414 discloses the treatment of carbon fibers with an active small molecule such as a strong acid, a strong base, or a strong oxidizing agent. These chemicals can only be used to treat fibers having high chemical resistances, such as activated carbon fibers. Further, fibers thus treated are potentially hazardous to handle.

U.S. Pat. No. 4,517,111 describes a composition comprising a permanganate salt adsorbed onto a solid alkaline support useful for irreversible removing formaldehyde in air. The composition may be employed in molded, pellet, particle, or power form as, for example, in a respirator filter cartridge. The application of this technology is limited to the solid forms as stated and is potentially hazardous to handle. U.S. Pat. No. 4,892,719 discloses a method of reducing the indoor air concentration of aldehydes by coating a porous support filter with a water soluble polymeric amine such as polyethyleneimine, polyallylamine, or polyvinylamine. The coating is further plasticized with a low volatile liquid such as glycerol in order to extend the useful life of the coating. This technology has a deficiency in that the reactive amine component may be consumed by carbon dioxide in air. The description of the reaction of carbon dioxide with amine adsorbents may be found in Int. J. Environmental Technology and Management, Vol. 4, Nos 1/2, 2004, p. 82. Furthermore, the reaction product of said polyamine and formaldehyde has the same end group as has urea-formaldehyde and, as a result, will undergo the same degradation to release formaldehyde over time.

It is known that compounds containing active methylene groups are capable of reacting with formaldehyde. JP 57,032,729 described a method for the removal of residual formaldehyde in microcapsule dispersion by adding a compound having active methylene groups such as methyl acetoacetate, ethyl acetoacetate, or diethyl malonate. Active methylene compounds also have been used as formaldehyde scavengers in the textile industry to reduce the amount of formaldehyde released from durable press-treated fabrics as described in Textile Chemist and Colorist, Vol. 16, No. 12, p. 33, December 1984 (published by the American Association of Textile Chemists and Colorists). Such formaldehyde scavengers may be added to textile finishing formulations to react with formaldehyde released from urea-formaldehyde resins used for cellulose crosslinking. Dimethyl 1,3-acetonedicarboxylate having two highly activated methylene groups was found to be most effective.

U.S. Pat. No. 5,160,503 discloses a composition for a textile formaldehyde scavenger consisting of a water-soluble blend of a substituted or unsubstituted polyhydric alcohol such as diethylene glycol and an active methylene compound selected from the group consisting of dialkyl malonates and alkyl acetoacetates. U.S. Pat. Nos. 5,194,674; 5,268,502; and 5,446,195 dusclose that water soluble compositions prepared by reacting a glycol or polyether with acetoacetate or malonate could be used as formaldehyde scavengers in the fabric finishing formulations.

The reaction of acetoacetate-functional polymers with formaldehyde also is described in the prior art. JP 58,059,263 discloses a curable polymer composition consisting of a water soluble polymer, a water soluble polymer containing aceto-acetate groups such as acetoacetylated polyvinyl alcohol resin, and a crosslinking agent capable of reacting with the acetoacetate group such as formaldehyde or glyoxal. U.S. Pat. No. 5,767,199 discloses an air-curable composition containing an acetoacetate functional polymer and an end-blocked polyformaldehyde chain. The composition described to be stable to reaction until formaldehyde is released from the polyformaldehyde chain.

Cigarette smoke resulting from tobacco combustion contains numerous gaseous and particulates compounds. The gaseous molecules are responsible for both the pleasure and the health risk derived from the use of tobacco smoke. Among the many molecules produced by combustion or vaporization of tobacco are nicotine, carbon monoxide, ammonia, aldehydes such as formaldehyde, acetaldehyde, and acrolein, and added flavor compounds and combustion products thereof. Cigarette filters are utilized in an effort to remove undesirable gases and particulates from tobacco smoke while retaining the flavor and taste essential to the enjoyment of smoking. Selective removal of gaseous molecules from tobacco smoke is required for an effective active, tobacco smoke filtration material. Active materials such as activated carbon, silica gel, alumina, and zeolites commonly used for the removal of gaseous contaminates are not particularly suitable for this purpose. Although these materials can remove certain gaseous compounds, they also may adsorb compounds considered desirable for acceptable cigarette flavor. Moreover, adsorption by these porous materials is not totally effective since the gaseous compounds are only physically bound to the surface of the porous materials and are not chemically reacted. In addition to selective adsorption of gaseous compounds, active tobacco smoke filter materials also should be light weight, low cost, stable in air, exhibit low pressure drop, safe to handle, and ease of fabrication.

U.S. Pat. No. 6,595,218 discloses a tobacco smoke filter comprising a reagent consisting essentially aminoethylaminopropylsilyl silica gel or aminoethylaminoethyl-(aminopropyl)silyl silica gel wherein the reagent chemically reacts with and removes a gaseous component such as an aldehydes from tobacco smoke. U.S. Pat. No. 6,481,442 discloses a smoking article comprising a wrapper and a selective filter element having at least one carrier and a polyaniline having a plurality of moieties selected from the group consisting of an amino group, an imino group, a hydrazide group, a hydrazone group, a semicarbazide group and combinations thereof capable of reacting with carbonyl-containing combustion products of tobacco. Optionally, a spacer, having the composition —CO—[CH₂]ₙ—CO—, wherein n has a value from 1 to 4 or greater than 4, may be used to attach active moieties containing amino groups to the carrier. The spacer is used for the purpose of extending out the chemically active amino moieties from the carrier.

U.S. Pat. No. 4,182,743 discloses a gas-permeable substrate, particularly adapted for the selective removal of aldehydes form gases comprising a granular-containing concentrated hydrogen peroxide, water and a hydrophilic stabilizer for the hydrogen peroxide. U.S. Pat. No. 4,753,250 discloses a process for producing cigarette filters comprising a compound containing L-ascorbic acid to react with and remove aldehydes. U.S. Pat. No. Re. 28,858 discloses an improved tobacco smoke filter material comprising a porous particulate carrier impregnated with polyethylene-imine for the removal of volatile smoke acids and aldehydes. U.S. Pat. No. 5,009,239 also relates to the removal of aldehydes using polyethyleneimine as the active component in a cigarette filter. For the same purpose, an aminobenzene acid salt is used in U.S. Pat. No. 5,603,927 and an organic salt of mercapto-alkane-sulfonate used in U.S. Pat. No. 4,532,947. Disclosed in U.S. Pat. No. 5,206,204 is an adsorbent for lower aldehydes which comprises a saturated cyclic secondary amine and a halogenide of an alkali metal or alkaline earth metal supported on a porous carrier.

A tobacco smoke filter comprising a plasticizer bonding agent is disclosed in U.S. Pat. No. 3,227,164, wherein the plasticizer is selected from the group consisting of the alkylene glycol, polyalkylene glycol, and glycerol esters of acetoacetic acid. This reference discloses that the tobacco smoke filter is effective in removing phenol and undesirable toxic metal ions such as nickel, cobalt, etc. Aldehydes removal is not mentioned.

U.S. Pat. No. 3,251,365 discloses a tobacco smoke filter comprising a particulate adsorbent material such as activated charcoal, alumina, natural and synthetic clays and silica gel. The particulate adsorbent material may be contained in a chamber of the tobacco smoke filter defined by a first filter plug section, a second filter plug section and the filter wrap. The filter plug section typically are constructed of a fibrous material such as cellulose acetate fibers or convoluted crepe paper. US-2004/0231684-A1 describes tobacco smoke filters comprising or containing activated carbon. This published application discloses that filters have been designed for the removal of gas-phase constituents along with particulates. These filters usually incorporate an adsorbent material such as activated carbon (also known as “carbon,” “charcoal,” or “activated charcoal”) in a section of the filter. Granular carbon having high surface area is recognized as an effective adsorbent for removing components such as aldehydes from mainstream smoke. Carbon granules have been dispersed within a cellulose acetate tow, paper web or filter plug wrap, sometimes called “dalmation” filters. A bed or charge of granular carbon has been placed into or within a cavity between two plugs of cellulose acetate tow in a so-called “plug-space-plug” or “triple filter” design. Examples of commercially available filters are Caviflex, Dualcoal, Recessed Dualcoal, Sel-X-4, and Triple Filter from Baumartner Fibertec (Switzerland); Active Acetate Dual, Active Charcoal Triple Solid, Active Myria White, Active Patch Mono, Adsorbent Coated Thread, Triple Granular, and V.P.A. Dual from Filtrona International Incorporated (Milton Keynes, U.K.).

### BRIEF SUMMARY OF THE INVENTION

We have discovered that certain compounds and polymeric compositions containing acetoacetate groups or residues may be used in particulate form as filter media for the purpose of removing airborne formaldehyde and/or other gaseous aldehydes such as acetaldehyde and acrolein from gases at ambient temperature. I Thus, the present invention provides a gas filter device comprising as the filter medium a particulate or finely-divided acetoacetate-functional compound or composition. The particulate or finely-divided filter medium of the present invention is characterized by being inherently reactive with formaldehyde and other gaseous aldehydes without the use of hazardous and destructive substances such as a strong oxidizing agent or a base. The particulate filter medium also is characterized by being gas-permeable and unsupported, i.e., the acetoacetate-functional compound or composition is not deposited on a support material. Another embodiment of the present invention is a method for the removal of a gaseous aldehyde from a gas such as air or tobacco smoke which comprises contacting a gas containing a gaseous aldehyde with a gas filter device comprising as the filter medium a particulate or finely-divided acetoacetate-functional compound or composition. Finally, another embodiment of the present invention is a dry, particulate, base-neutralized acetoacetate-functional addition polymer having a glass transition temperature (Tg) >40° that is not film-forming.

The present invention provides a novel filter medium based on a reactive material capable of irreversibly removing airborne formaldehyde. The reactive material is inherently reactive with formaldehyde and does not require treatment with a destructive substance such as an oxidizing agent or a base. In addition to being reactive with formaldehyde, the reactive acetoacetate-functional compounds or compositions are stable in contact with common fibers such as cellulose, cotton, and synthetic polymers typically used to confine the particulate or finely-divided reactive filter media. The aldehyde removal forms a reaction product of the acetoacetate reactive material and aldehyde, and the reaction is irreversible. Consequently, the adsorbed formaldehyde molecules are not released over time or at elevated temperatures. Thus, the present invention provides a low-cost, versatile, and effective solution to permanently remove airborne aldehydes including formaldehyde in gaseous streams such as air and tobacco smoke.

### DETAILED DESCRIPTION OF THE INVENTION

The present invention utilizes a compound and/or composition containing acetoacetate groups or residues in particulate or finely-divided form, i.e., in a physical form that permits the transmission of gases through a container, cartridge or bed containing the compound or composition. The particulate acetoacetate-functional compound may be a solid small molecule, a solid oligomer or adduct, or a polymer. Examples of particulate acetoacetate-functional small molecules include alkyl acetoacetates that are solids at ambient or room temperature. Examples of particulate acetoacetate-functional solid adducts include solid adducts prepared by reacting a diol or a polyol with diketene or an acetoacetate-functional small molecule. An example of such an adduct is cyclohexanedimethanol-bisacetoacetate (1,2-, 1,3- and 1,4-bis(acetoaetoxymethyl)cyclohexane)).

The particulate acetoacetate-containing composition preferably is an acetoacetate functionalized polymers (AcAc polymers or AcAc polymeric materials) having a Tg greater than about 40° C., typically about 50 to 100° C. Examples of AcAc polymers include polyesters, polyacrylates, acrylics, polyethers, polyurethanes, polyolefins, polyvinyl alcohols, polysiloxanes, and cellulose esters. The preferred Tg of the dry, particulate AcAc polymers is greater than about 50° C., typically about 70 to 100° C. The AcAc polymers may be prepared by reacting a polymer containing hydroxyl groups with an alkyl acetoacetate or diketene. Various methods for the preparation of acetoacetylated polyester coating resins have been described by J. S. Witzeman et al. in the Journal of Coatings Technology, Vol. 62, No. 789, pp. 101-112 (1990). Suitable alkyl acetoacetates for the reaction with a hydroxyl functional polymer include t-butyl acetoacetate, ethyl acetoacetate, methyl acetoacetate, isobutyl acetoacetate, isopropyl acetoacetate, n-propyl acetoacetate, and n-butyl acetoacetate. t-Butyl acetoacetate is preferred.

A preferred particulate AcAc polymer is an acrylic polymer containing acetoacetate groups obtained by isolating and drying the AcAc polymer from an acrylic latex emulsion. Water may be removed from an acrylic latex emulsion at room temperature or elevated temperatures. The resulting solid AcAc acrylic polymer then may be processed into a particulate or finely-divided form by a variety of methods such as grinding, blending, pulverizing, spray drying, etc. Since the AcAc acrylic polymers are used in the invention in a particulate form, the AcAc acrylic polymers do not form continuous films when dried. Acrylic latex compositions typically are used for paint or coating applications and thus AcAc acrylic polymers of such latex compositions are not suitable for the present invention since the latex compositions are required to form continuous films when dried in order to protect the surface coated.

Latex emulsions of AcAc acrylic polymers may be prepared according to known procedures by chain-growth copolymerization of an ethylenically unsaturated monomer having AcAc functionality with other ethylenically unsaturated monomers. The preferred method for chain-growth copolymerization is free-radical emulsion polymerization to yield latexes having acrylic AcAc polymers dispersed in water. The preparation of a latex polymer emulsion containing 2-acetoacetoxyethyl methacrylate (AAEM) as one of the acrylic monomers has been reported as early as in 1971 in U.S. Pat. No. 3,554,987. Alternatively, the AcAc acrylic polymers may be prepared by solution polymerization such as the procedures described in U.S. Pat. No. 5,391,624. Examples of ethylenically unsaturated monomers having AcAc functionality include 2-acetoacetoxyethyl acrylate, 2-acetoacetoxyethyl methacrylate, 2-acetoacetoxypropyl methacrylate, 2-acetoacetoxypropyl acrylate, and acetoacetate esters of other hydroxyalkyl acrylate and methacrylate esters. Suitable ethylenically unsaturated monomers that may be used to copolymerize with the above acetoacetate-functional monomers to yield AcAc acrylic polymers include, but are not limited to, methyl acrylate, methyl methacrylate, ethyl acrylate, ethyl methacrylate, butyl acrylate, butyl methacrylate, isobutyl acrylate, isobutyl methacrylate, ethylhexyl acrylate, 2-ethylhexyl methacrylate, 2-ethyl hexyl acrylate, isoprene, octyl acrylate, octyl methacrylate, iso-octyl acrylate, iso-octyl methacrylate, trimethyolpropyl triacrylate, styrene, α-methyl styrene, vinyl naphthalene, vinyl toluene, chloromethyl styrene, glycidyl methacrylate, carbodiimide methacrylate, C₁-C₁₈ alkyl crotonates, di-n-butyl maleate, α or-β-vinyl naphthalene, di-octyl maleate, allyl methacrylate, di-allyl maleate, di-allyl malonate, methyoxybutenyl methacrylate, isobornyl methacrylate, hydroxybutenyl methacrylate, 2-hydroxyethyl (meth)acrylate, hydroxypropyl(meth)acrylate, acrylonitrile, vinyl chloride, vinylidene chloride, vinyl acetate, vinyl ethylene carbonate, epoxy butene, 3,4-dihydroxybutene, hydroxyethyl(meth)acrylate, methacrylamide, acrylamide, butyl acrylamide, ethyl acrylamide, diacetoneacryl-amide, butadiene, vinyl ester monomers, vinyl(meth)acrylates, isopropenyl(meth)acrylate, cycloaliphaticepoxy(meth)acrylates, ethylformamide, 4-vinyl-1,3-dioxolan-2-one, 2,2-dimethyl-4 vinyl-1,3-dioxolane, 3,4-di-acetoxy-1-butene, acrylic acid, methacrylic acid, itaconic acid, crotonic acid, and monovinyl adipate. t-butylaminoethyl methacrylate, dimethylaminoethyl methacrylate, diethylaminoethyl methacrylate, N,N-dimethylaminopropyl methacrylamide, 2-t-butylaminoethyl methacrylate, N,N-dimethylaminoethyl acrylate, N-(2-methacryloyloxy-ethyl)ethylene urea, and methacrylamido-ethylethylene urea. Further monomers are described in The Brandon Associates, 2nd edition, 1992 Merrimack, N.H., and in Polymers and Monomers, the 1966-1997 Catalog from Polyscience, Inc., Warrington, Pa., U.S.A. The AcAc acrylic polymers typically have a Tg of about 40 to 100° C. and comprise polymerized residues of:
(1) about 10 to 80 weight percent of residues of 2-acetoacetoxyethyl acrylate, 2-acetoacetoxyethyl methacrylate, 2-acetoacetoxypropyl methacrylate, 2-acetoacetoxypropyl acrylate, or a mixture of any two or more thereof; and
(2) about 20 to 90 weight percent of residues of methyl methacrylate, butyl acrylate, styrene, 2-ethylhexyl acrylate, methacrylic acid, acrylic acid, or a mixture of any two or more thereof; wherein the weight percentages are based on the total weight of the AcAc polymer.

### The particulate filter media comprising an addition polymer containing both AAEM and methacrylic acid have been found to be especially effective in adsorbing formaldehyde both at room temperature and at 100° C.

The preferred dry, particulate, AcAc acrylic polymers have a Tg of about 50 to 100° C. and comprise polymerized residues of:
(1) about 20 to 60%, based on the total weight of (1), (2), and (3), of an ethylenically unsaturated monomer having acetoacetate functionality, especially an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer other than methacrylic acid or acrylic acid.
   Especially preferred dry, particulate, AcAc acrylic polymers are those wherein (1) is 2-acetoacetoxyethyl methacrylate residues and (3) is selected from methyl methacrylate, styrene, n-butyl acrylate, and 2-ethylhexyl acrylate, particularly methyl methacrylate and styrene.

The polymerization process by which the water-based latex dispersions are made also may require an initiator, a reducing agent, or a catalyst. Suitable initiators include conventional initiators such as ammonium persulfate, ammonium carbonate, hydrogen peroxide, t-butylhydroperoxide, ammonium or alkali sulfate, di-benzoyl peroxide, lauryl peroxide, di-tertiarybutylperoxide, 2,2′-azobisisobuteronitrile, benzoyl peroxide, and the like. Suitable reducing agents are those which increase the rate of polymerization and include, for example, sodium bisulfite, sodium hydrosulfite, sodium formaldehyde sulfoxylate, ascorbic acid, isoascorbic acid, and mixtures thereof. Suitable catalysts are those compounds which promote decomposition of the polymerization initiator under the polymerization reaction conditions thereby increasing the rate of polymerization. Suitable catalysts include transition metal compounds and driers. Examples of such catalysts include, but are not limited to, ferrous sulfate heptahydrate, ferrous chloride, cupric sulfate, cupric chloride, cobalt acetate, cobaltous sulfate, and mixtures thereof. Optionally, a conventional surfactant or a combination of surfactants may be used as a costabilizer or cosurfactant, such as an anionic or non-ionic emulsifier, in the suspension or emulsion polymerization preparation of a hybrid latex of the invention. Examples of preferred surfactants include, but are not limited to, alkali or ammonium alkylsulfate, alkylsulfonic acid, or fatty acid, oxyethylated alkylphenol, or any combination of anionic or non-ionic surfactant. A more preferred surfactant monomer is HITENOL HS-20 (which is a polyoxyethylene alkylphenyl ether ammonium sulfate available from DKS International, Inc. of Japan). A list of suitable surfactants is available in the treatise: McCutcheon's Emulsifiers & Detergents, North American Edition and International Edition, MC Publishing Co., Glen Rock, N.J., 1993.

The surface area and, as a result, the adsorption efficiency of the dry, particulate AcAc acrylic polymers may be increased by means of various methods described in the literature for creating voids and channels in the latex particles. U.S. Pat. Nos. 4,427,836 and 4,468,498 disclose a process for making an aqueous dispersion of the acid-containing core/sheath particles by sequential emulsion polymerization followed by neutralization with a base such as ammonium hydroxide or potassium hydroxide. Latex particles thus prepared form microvoids in cores of the swollen particles during the drying process thereby increasing the surface area. The AcAc acrylic polymers of the present invention may contain both carboxylic acid residues, e.g., derived from acrylic and/or methacrylic acid, as well as acetoaceate residues that may be neutralized. U.S. Pat. No. 5,527,613 discloses a latex capsule composition having microvoids in the core and one or more channels connecting the microvoids to the exterior of the particles. These particles are produced by forming a core of polymeric acid, encasing the core in a shell polymer permeable to base, and then neutralizing the core such that the core swells, causing the shell to “explode” in a controlled fashion. This controlled explosion causes channels to form in the shell.

U.S. Pat. No. 4,522,953 discloses low density, crosslinked, porous polymeric materials that are prepared by polymerization of monomers as the continuous phase in a high internal phase emulsion. The resulting water-filled polymer can then be dried to yield a solid with interconnected voids. By using the methods described above, porous, particulate AcAc acrylic polymers wherein the particles have voids, cavities, and/or channels may be prepared. Thus, in yet another aspect, the particulate AcAc polymer comprises dry, porous particles of an AcAc acrylic polymer wherein the particles have voids, cavities, and/or channels.

The adsorption efficiency of the AcAc polymers utilized in the present invention may be further improved by neutralization of the AcAc polymer with a base during or after preparation. Suitable bases for neutralization include alkali metal hydroxides such as sodium hydroxide and potassium hydroxide, ammonia or ammonium hydroxide, and amines such as triethylamine, N,N-dimethylethanolamine, and the like. As used herein, neutralization of a polymer means to neutralize carboxylic acid groups and/or AcAc residues. Neutralization of carboxylic acid groups may render the polymer water-dispersible through ionic group formation, where the final pH may still be <7. On the other hand, neutralization of AcAc functionality typically results in an increase of the pH to >7, preferably about 7.5 to 11, to increase the reactivity toward formaldehyde. Thus, in another aspect, the dry, particulate acetoacetate-functional polymers employed in the present invention is a base-neutralized AcAc polymer, i.e., an AcAc polymer neutralized during or after preparation and prior to drying. The preferred pH of the neutralized acetoacetate-functional polymers, measured when the neutralized polymers are in the form of an aqueous latex, is 7.5 to 10.5.

The particulate filter media comprising a particulate or finely-divided acetoacetate-functional compound or composition may include a mild oxidizing agent which does not attack the AcAc compound or composition to enhance the efficiency of the filter media of the present invention. Thus, in another embodiment, the particulate, acetoacetate-functional compounds and compositions of the present invention further comprises a mild oxidizing agent. Examples of mild oxidizing agents include compounds of Cu(II), Mn(IV), Fe(III), and Sn(IV). The amount of mild oxidizing agent employed typically is less than 10 weight percent, based on the weight of the dry, particulate AcAc compound or composition. Oxidation catalysts may be included in the dry, particulate AcAc compounds or compositions to catalyze the oxidation of formaldehyde to formate or other products in the presence of oxygen in air. Addition of such oxidation catalysts to the AcAc polymers therefore can enhance the efficiency of the particulate filter media of the invention. Examples of oxidation catalysts include compounds of Cu(II), Co(II), Zr(II), Ca(II), and Fe(III). The oxidation catalyst may form a complex with the acetoacetate functionality of the AcAc compounds or compositions. Metal acetylacetonates are known to be particularly effective oxidation catalysts for oxidation reactions in the presence of molecular oxygen. Metal compounds that may be added to the AcAc polymer dispersion to function as oxidation catalysts includes salts of Cu(II), Co(II), Co(III), Zr(II), Ca(II), Fe(III), VO(II), Al(III), and Cr(III). Examples of such salts include CuSO₄, CuCl₂, Al₂(SO₄)₃, CrCl₃, FeCl₃, CoCO₃, and CoCl₂. The most preferred are Cu(II) compounds. Although not economically favored, preformed metal acetylacetonates of said metal ions may also be used in lieu of said metal salts. Preferred ratio of the metal compounds is <5%, based on the weight of the AcAc compound. Although the present invention pertains primarily to the removal of airborne aldehydes, the removal of other airborne contaminants, volatile organic compounds (VOC), and chemical toxins that are subject to nucleophilic or oxidation reactions is within the scope of this invention.

The particulate filter media provided by the present invention comprises a dry, particulate or finely divided acetoacetate-functional compound or composition that is effective in removing gaseous aldehydes present in gases such as air and tobacco smoke. The dry, unsupported, particulate filter media may be employed in gas filter devices such as filter beds, filter cartridges and tobacco smoke filters. NAFA Guide to Air Filtration, 3^{rd} Edition, 2001, National Air Filtration Association, Washington, D.C. described various air filters. Filter beds and filter cartridges containing the dry, unsupported, particulate filter media are gas permeable, i.e., the filter beds and filter cartridges permit the passage of gases such as air without an excessive pressure drop across the bed or cartridge containing the filter media. Thus, the dry, unsupported, particulate filter media normally has an average particle size of about 0.1 to 5 millimeters. Tobacco smoke filters comprising or containing the dry, unsupported, particulate filter media may be constructed in the manner described in U.S. Pat. No. 3,251,365 and US Published Application 2004/0231684 by substituting the present particulate material for the particulate material utilized in the filters described in those patent documents. The dry, unsupported, particulate filter media described herein may be employed in combination or admixture with the particulate materials, e.g., activated carbon, described in the cited patent documents.

### EXAMPLES

The preparation of the particulate filter media of the present invention and the use thereof to adsorb formaldehyde are further illustrated by the following examples wherein all percentages are by weight unless specified otherwise.

### Example 1

This example describes the procedure for preparing an AcAc acrylic polymer comprising 40% AAEM and having a Tg of 76° C. To a 1-L, water-jacketed kettle equipped with a mechanical stirrer, a water condenser, a nitrogen inlet, and reactant feeding tubes were added water (124.00 g), sodium lauryl sulfate (SLS, 0.37 g), and ammonium carbonate (0.41 g). The mixture then was gradually heated to 80° C. Three solutions were prepared in separate flasks: (1) an initiator solution of ammonium persulfate (APS, 0.90 g), ammonium carbonate (0.92 g), and water (25.00 g), (2) a kicker solution of ammonium persulfate (0.48 g) and water (12.53 g), and (3) a monomer pre-emulsion of methyl methacrylate (206.90 g), methacrylic acid (14.78 g), 2-acetoacetoxyethyl methacrylate (AAEM, 147.80 g), SLS (3.33 g), water (350.00 g), and the chain transfer agent, isooctyl 3-mercaptopropionate (IOMP, 1.85 g).

A portion (37.10 g) of the above monomer pre-emulsion was added to the kettle at 80° C., followed by the addition of the above kicker solution. The mixture was allowed to react for 30 minutes to yield latex seed particles. The initiator solution and the monomer pre-emulsion then were fed simultaneously into the reaction kettle over 210 minutes. After the feeding was complete, the reaction was allowed to continue for another 30 minutes. A chaser solution of APS (0.37 g) in water (6.83 g) then was fed into the mixture over one hour to ensure the completion of the reaction. After the chaser addition was complete, the reaction mixture was held for 30 minutes and subsequently terminated by lowering the temperature to room temperature. The resulting emulsion then was filtered through a 100-mesh wire screen, and its % solids and average particle size determined: % Solids=41.0%; PS=179 nm. Average particle size was determined by using Microtrac UPA 150 available from Microtrac, Inc. (Montgomeryville, Pa.) based on a dynamic light scattering method. A 10 gram sample of the emulsion product was placed in an aluminum pan and allowed to dry at room temperature overnight. The dried AcAc acrylic polymer then was placed in a vial and ground with a stirring rod to produce a particulate filter medium comprising the AcAc acrylic polymer particles.

### Example 2

This example describes the procedure for preparing an AcAc acrylic polymer comprising 20% MEM and having a Tg of 100° C. using a two-stage method. To a 1-L, water-jacketed kettle equipped with a mechanical stirrer, a water condenser, a nitrogen inlet, and reactant feeding tubes were added water (124.00 g), sodium lauryl sulfate (SLS, 0.37 g), and ammonium carbonate (0.41 g). The mixture then was gradually heated to 80° C. Four solutions were prepared in separate flasks: (1) an initiator solution of ammonium persulfate (APS, 0.90 g), ammonium carbonate (0.92 g), and water (25.00 g), (2) a kicker solution of ammonium persulfate (0.48 g) and water (12.53 g), (3) a first monomer pre-emulsion of methyl methacrylate (92.38 g), methacrylic acid (18.48 g), acetoacetoxyethyl methacrylate (AAEN, 73.90), SLS (1.67 g), and water (220.00 g), and (4) a second monomer pre-emulsion of methyl methacrylate (184.75 g), SLS (1.66 g), and water (180.00 g).

A portion (40.00 g) of the first monomer pre-emulsion was added to the kettle at 82° C., followed by the addition of the above kicker solution. The mixture was allowed to react for 30 minutes to yield latex seed particles. The initiator solution and the first monomer pre-emulsion then were fed simultaneously into the reaction kettle over 105 minutes. Immediately after the feeding of the first monomer pre-emulsion was complete, the feeding of the second monomer pre-emulsion began. The reaction was allowed to continue for another 105 minutes. After the addition of the monomers and initiators was complete, the reaction was held at 82° C. for 30 minutes. A chaser solution of APS (0.37 g) in water (6.83 g) then was fed into the mixture over one hour to ensure the completion of the reaction. After the chaser addition was complete, the reaction was held for 30 minutes and subsequently terminated by lowering the temperature to room temperature. The resulting emulsion then was filtered through a 100-mesh wire screen, and its % solids and average particle size determined: % Solids=39.8%; PS=242 nm. A portion (10 g) of the emulsion product was placed in an aluminum pan and allowed to dry at room temperature overnight. The dried AcAc acrylic polymer then was placed in a vial and ground with a stirring rod to produce a particulate filter medium comprising the AcAc acrylic polymer particles.

### Example 3

To a sample (100.0 g) of the latex of Example 2 in a 500 mL-flask was added 6.8 g KOH (10% in water). The mixture was stirred at 85° C. for 30 minutes and then allowed to cool while the stirring continued for an additional 1.5 hours. The final mixture had a pH of 7.6. The neutralized material was dried and ground as described above.

### Example 4

This example describes the procedure for preparing an AcAc acrylic polymer comprising 40% AAEM and having a Tg of 77° C. using a two-stage method. To a 1-L, water-jacketed kettle equipped with a mechanical stirrer, a water condenser, a nitrogen inlet, and reactant feeding tubes were added water (120.00 g), sodium lauryl sulfate (SLS, 0.37 g), and ammonium carbonate (0.41 g). The mixture then was gradually heated to 80° C. Four solutions were prepared in separate flasks: (1) an initiator solution of ammonium persulfate (APS, 0.90 g), ammonium carbonate (0.92 g), and water (25.00 g), (2) a kicker solution of ammonium persulfate (0.48 g) and water (12.53 g), (3) a first monomer pre-emulsion of methyl methacrylate (107.17 g), methacrylic acid (18.48 g), acetoacetoxyethyl methacrylate (AAEM, 59.10 g), SLS (1.56 g), and water (220.00 g), (4) a second monomer pre-emulsion of methyl methacrylate (96.05 g), acetoacetoxyethyl methacrylate (AAEM, 88.70), SLS (1.55 g), and water (180.00 g).

A portion (40.00 g) of the first monomer pre-emulsion was added to the kettle at 82° C., followed by the addition of the above kicker solution. The mixture was allowed to react for 30 minutes to yield latex seed particles. The initiator solution and the first monomer pre-emulsion then were simultaneously fed into the reaction kettle over 105 minutes. Immediately after the completion of the addition of the first monomer pre-emulsion, the feeding of the second monomer pre-emulsion began. The reaction was allowed to continue for another 105 minutes. After the completion of feeding monomers and initiators, the reaction was held at 82° C. for 30 minutes. A chaser solution of APS (0.37 g) in water (6.83 g) was fed into the mixture over one hour to ensure the completion of the reaction. After the chaser addition was complete, the reaction was held for 30 minutes and subsequently terminated by lowering the temperature to room temperature. The resulting emulsion then was filtered through a 100-mesh wire screen, and its % solids and average particle size determined: % Solids=40.0%; PS=189 nm. A portion (10 g) of the emulsion product was placed in an aluminum pan and allowed to dry at room temperature overnight. The dried AcAc acrylic polymer then was placed in a vial and ground with a stirring rod to produce a particulate filter medium comprising the AcAc acrylic polymer particles.

### Example 5

To a sample (100.0 g) of the latex prepared as described in Example 4 in a 500 mL-flask was added 2.7 g NH₄0H (30% in water). The mixture was stirred at 85° C. for 30 minutes and then at 90° C. for an additional 30 minutes. The final mixture had a pH of 7.6. Unlike the latex of Example 2, the latex of Example 4 was found to form a heterogeneous mixture when neutralized with KOH. This problem was resolved by replacing KOH with NH₄OH (30% in water) as described above; a homogeneous emulsion was obtained after neutralization at elevated temperatures. The neutralized material was dried and ground as described above.

### Example 6

This example describes the procedure for preparing an AcAc acrylic polymer comprising 60% MEM and having a Tg of 56° C. using a two-stage method. To a 1-L, water-jacketed kettle equipped with a mechanical stirrer, a water condenser, a nitrogen inlet, and reactant feeding tubes were added water (120.00 g), sodium lauryl sulfate (SLS, 0.60 g), and ammonium carbonate (0.41 g). The mixture then was gradually heated to 80° C. Four solutions were prepared in separate flasks: (1) an initiator solution of ammonium persulfate (APS, 0.90 g), ammonium carbonate (0.92 g), and water (25.00 g), (2) a kicker solution of ammonium persulfate (0.48 g) and water (12.53 g), (3) a first monomer pre-emulsion of methyl methacrylate (70.20 g), methacrylic acid (18.48 g), acetoacetoxyethyl methacrylate (AAEM. 96.07 g), SLS (1.56 g), and water (220.00 g), and (4) a second monomer pre-emulsion of methyl methacrylate (59.12 g), acetoacetoxyethyl methacrylate (AAEM, 125.60 g), SLS (1.55 g), and water (180.00 g).

A portion (40.00 g) of the first monomer pre-emulsion was added to the kettle at 82° C., followed by the addition of the above kicker solution. The mixture was allowed to react for 30 minutes to yield latex seed particles. The initiator solution and the first monomer pre-emulsion then were fed simultaneously into the reaction kettle over 105 minutes. Immediately after the addition of the first monomer pre-emulsion was complete, feeding of the second monomer pre-emulsion began. The reaction was allowed to continue for another 105 minutes. After the addition of the monomers and initiators was complete, the reaction was held at 82° C. for 30 minutes. A chaser solution of APS (0.37 g) in water (6.83 g) was fed into the mixture over one hour to ensure the completion of the reaction. After the chaser addition was complete, the reaction was held for 30 minutes and subsequently terminated by lowering the temperature to room temperature. The resulting emulsion then was filtered through a 100-mesh wire screen, and its % solids and average particle size determined: % Solids=40.0%; PS=206 nm. A portion (10 g) of the emulsion product was placed in an aluminum pan and allowed to dry at room temperature overnight. The dried AcAc acrylic polymer then was placed in a vial and ground with a stirring rod to produce a particulate filter medium comprising the AcAc acrylic polymer particles.

### Example 7

To a sample (100.0 g) of the latex of Example 6 in a 500 mL-flask, was added 2.7 g NH₄OH (30% in water). An increase in viscosity was observed. The mixture was stirred at 65-80° C. for one hour, during which water (33 g) was added to reduce the viscosity of the mixture. The final mixture had a pH of 7.7. The mixture was dried to yield a solid, neutralized polymer that was difficult to break into fine particles and, as a result, small flakes having a size of about 1-5 mm were used in the evaluation of the AcAc polymer for formaldehyde adsorption.

### Example 8

The dried solids of the latexes neutralized with NH₄OH (Examples 5 & 7) were found to be difficult to break into fine powders. A finer powder was obtained by spreading a thin layer of the latex of Example 6 on a glass slide and allowing it to dry at room temperature. The dried thin layer was collected and ground into fine powders.

### Example 9

To the latex of Example 4 (10 g) was added 0.25 g NH₄OH (30%), and the resulting mixture was allowed to age for 20 days at room temperature. The final mixture has pH of 9.3. The neutralized material was dried and ground as described above.

### Example 10

An aliquot of the latex of Example 5 was placed in an aluminum pan and allowed to dry at room temperature overnight. The dried solid then was pressed with a stirring rod in a vial to produce a particulate, AcAc acrylic polymer, from which a sample of finer powders was selected for evaluation in the adsorption of formaldehyde.

### Example 11

A sample of coarse particles selected from the particulate AcAc acrylic polymer of Example 10 was evaluated for formaldehyde adsorption.

The particulate filter media prepared in the preceding examples were evaluated for formaldehyde absorption/reactivity by means of gas chromatography (GC). GC samples were prepared by placing a 0.5 g of each particulate filter medium in a 20-ml screw top headspace vial. A small vial also was inserted into the GC vial for the addition of formaldehyde solution. Standard solutions of formaldehyde were prepared by diluting a 37% formaldehyde in water solution (containing 10 to 15% methanol) with water or water and acetone. The standard formaldehyde solutions contained 2590 μg (2590 parts per million by volume—ppmv) formaldehyde per ml. A predetermined amount of formaldehyde standard solution was injected by means of a syringe into the small vial inside the sample vial and allowed to vaporize to provide a known concentration of formaldehyde. For example, when 1.0-microliter (μl) of standard formaldehyde solution is fully evaporated into a 20.0-ml headspace vial and the ideal gas law is applied, the theoretical concentration of formaldehyde in the 20-ml headspace vial is 100 ppmv. The added formaldehyde solution is not in contact with the particulate filter medium. The headspace vial then was hermetically sealed with a Silicone/TFE septum screw cap. Each prepared headspace vial was then subjected to the desired condition, such as at 100° C. for 30 minutes or at room temperature (22° C.) for 60 minutes. The standard formaldehyde solution containing acetone was used in the evaluations at room temperature.

The determination of formaldehyde (ppmv) remaining in the headspace after 30 or 60 minutes was accomplished by using an automated headspace injector (CTC Combi-PAL by Leap Technologies) and a HP-6890 gas chromatograph (Agilent Technologies) with a heated split injector and a pulsed discharge detector (PDD) (Valco Instruments Co. Inc.). A 2.0-ml aliquot of the headspace air was injected onto the GC inlet (250° C.) and formaldehyde was separated from other components by using a RTX-624 capillary column (75 meters×0.53 mmID×3.0 μm film thickness, Restek Corporation) with helium carrier gas at a constant flow of 3.0 ml/min, an GC oven temperature program (initial temperature of 40° C., initial hold time of 5 minutes, increased to 150° C. at 15° C./minute), and detected by the PDD in helium ionization mode (150° C.). The retention time of formaldehyde peak was 8.95 minutes. A series of headspace vials containing various amounts, e.g., 0.5, 1.0, and 2.0-μL, of formaldehyde standard solution, e.g., 2590 μg/ml, were prepared and analyzed under the same headspace and GC conditions to construct a linear calibration curve for formaldehyde quantification. The ppmv concentration of formaldehyde remaining in the headspace after exposing to the particulate filter medium under the desired condition then was calculated.

The particulate filter media of Examples 1, 2 and 3 were evaluated according to the above-described procedure by exposing each particulate filter media to formaldehyde at room temperature (22° C.) for 60 minutes. At the end of the 60-minute period, the headspace of each vial employed in the evaluation was analyzed by GC. The results are reported in Table I wherein Example refers to the example wherein the preparation of the particulate filter medium evaluated in described, HCHO Theory is the theoretical concentration of formaldehyde (parts per million volume/volume—ppmv) in the headspace based on the amount of formaldehyde introduced into the smaller vial, HCHO After refers to the concentration of formaldehyde (ppmv) detected by GC in the headspace vial after the 60-minute exposure to a particulate filter medium and ND means None Detected, i.e., no formaldehyde was detected by GC analysis.

TABLE I

| | HCHO | HCHO |
|---|---|---|
| Example | Theory | After |
| 1 | 136.0 | ND |
| 2 | 136.0 | ND |
| 3 | 136.0 | ND |

Each of the headspace vials employed in the above-described evaluation of the particulate filter media of Examples 1, 2 and 3 at room temperature was resealed and heated to 100° C. for 15 minutes. The headspaces of the vials then were again analyzed for the presence of formaldehyde released from the particulate filter media. No formaldehyde was detected in all vials indicating that the adsorptions were irreversible under the evaluation conditions.

The above-described evaluation of the particulate filter media of Examples 1, 2 and 3 at room temperature (22° C.) for 60 minutes was repeated except that the amount of each particulate filter medium used was 0.016 g rather than 0.5 g. The results are reported in Table II wherein Example, HCHO Theory, HCHO After and ND have the meanings given above.

TABLE II

| | HCHO | HCHO |
|---|---|---|
| Example | Theory | After |
| 1 | 94.7 | 22.87 |
| 2 | 94.7 | 8.53 |
| 3 | 94.7 | ND |

The superior effectiveness of the particulate filter medium of Example 2 may be due to variation in particulate surface area which was not controlled and normalized. The neutralized particulate filter medium of Example 3 was found to be more effective than the un-neutralized particulate filter medium of Example 2.

The particulate filter media of Examples 4, 5, 6, 7 and 8 were evaluated according to the above-described procedure by exposing 0.0165 g of each particulate filter media to formaldehyde at room temperature (22° C.) for 60 minutes. At the end of the 60-minute period, the headspace of each vial employed in the evaluation was analyzed by GC. The results are reported in Table III wherein Example, HCHO Theory (ppmv) and HCHO After (ppmv) have the meanings given above.

TABLE III

| | HCHO | HCHO |
|---|---|---|
| Example | Theory | After |
| 4 | 125.0 | 34.2 |
| 5 | 125.0 | 3.5 |
| 6 | 125.0 | 11.4 |
| 7 | 125.0 | 70.9 |
| 8 | 125.0 | 13.3 |

The neutralized Example 5 particulate filter medium exhibits a very low detection which is consistent with the neutralized Example 3 particulate filter medium. The un-neutralized Example 6 particulate filter medium containing 60% AAEM shows an improvement over the Example 4 material which also is un-neutralized but contains a lower percent AAEM (40%).

The particulate filter media of Examples 4, 9, 10, and 11 were evaluated according to the above-described procedure by exposing 0.0161 to 0.0165 g of each particulate filter media to formaldehyde at room temperature (22° C.) for 60 minutes. At the end of the 60-minute period, the headspace of each vial employed in the evaluation was analyzed by GC. The results are reported in Table IV wherein Example, HCHO Theory (ppmv), HCHO After (ppmv) and ND have the meanings given above.

TABLE IV

| | HCHO | HCHO |
|---|---|---|
| Example | Theory | After |
| 4 | 110.0 | 17.4 |
| 9 | 110.0 | ND |
| 10 | 110.0 | 0.3 |
| 11 | 110.0 | 14.0 |

The invention has been described in detail with particular reference to preferred embodiments thereof, but it will be understood that variations and modifications can be effected within the spirit and scope of the invention.

We claim:

1. A gas filter device comprising as the filter medium a particulate or finely-divided acetoacetate-functional compound or composition.

2. A gas filter device according to claim 1 comprising a filter bed, filter cartridge or tobacco smoke filter containing as the filter medium an unsupported, particulate or finely-divided acetoacetate-functional compound or composition selected from small molecules, oligomers and polymers containing acetoacetate residues.

3. A gas filter device according to claim 1 comprising as the filter medium an unsupported, particulate acetoacetate-functional polymer selected from polyesters, polyacrylates, acrylics, polyethers, polyurethanes, polyolefins, polyvinyl alcohols, polysiloxanes, and cellulose esters.

4. A gas filter device according to claim 1 comprising as the filter medium an unsupported, particulate acetoacetate-functional acrylic polymer having a glass transition temperature greater than about 40° C.

5. A gas filter device according to claim 1 comprising as the filter medium an unsupported, particulate acetoacetate-functional acrylic polymer having a glass transition temperature of about 40 to 100° C. and comprising polymerized residues of:
(1) about 10 to 80 weight percent of residues of 2-acetoacetoxyethyl acrylate, 2-acetoacetoxyethyl methacrylate, 2-acetoacetoxypropyl methacrylate, 2-acetoacetoxypropyl acrylate, or a mixture of any two or more thereof; and
(2) about 20 to 90 weight percent of residues of methyl methacrylate, butyl acrylate, styrene, 2-ethylhexyl acrylate, methacrylic acid, acrylic acid, or a mixture of any two or more thereof; wherein the weight percentages are based on the total weight of the AcAc polymer.

6. A gas filter device comprising a filter bed, filter cartridge or tobacco smoke filter containing as the filter medium the unsupported, particulate or finely-divided acetoacetate-functional polymer of claim 5.

7. A gas filter device according to claim 1 comprising as the filter medium an unsupported, particulate acetoacetate-functional acrylic polymer having a glass transition temperature of about 50 to 100° C. and comprising polymerized residues of:
(1) about 20 to 60%, based on the total weight of (1), (2), and (3), of an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer other than methacrylic acid or acrylic acid.

8. A gas filter device comprising a filter bed, filter cartridge or tobacco-smoke filter containing as the filter medium the unsupported, particulate or finely-divided acetoacetate-functional polymer of claim 7.

9. A gas filter device according to claim 1 comprising as the filter medium an unsupported, particulate acetoacetate-functional acrylic polymer having a glass transition temperature of about 50 to 100° C. and comprising polymerized residues of:
(1) about 20 to 60%, based on the total weight of (1), (2), and (3), of 2-acetoxyethyl methacrylate;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer selected from methyl methacrylate, styrene, n-butyl acrylate, and 2-ethylhexyl acrylate.

10. A dry, particulate, base-neutralized acetoacetate-functional acrylic polymer having a glass transition temperature greater than about 40° C.

11. A dry, particulate, base-neutralized polymer according to claim 10 having a glass transition temperature of about 40 to 100° C. and comprising polymerized residues of:
(1) about 10 to 80 weight percent of residues of 2-acetoacetoxyethyl acrylate, 2-acetoacetoxyethyl methacrylate, 2-acetoacetoxypropyl methacrylate, 2-cetoacetoxypropyl acrylate, or a mixture of any two or more thereof; and
(2) about 20 to 90 weight percent of residues of methyl methacrylate, butyl acrylate, styrene, 2-ethylhexyl acrylate, methacrylic acid, acrylic acid or a mixture of any two or more thereof; wherein the weight percentages are based on the total weight of the AcAc polymer;
wherein the acetoacetate residues are neutralized or reacted with a base.

12. A dry, particulate, base-neutralized polymer according to claim 10 having a glass transition temperature of about 50 to 100° C. and comprising polymerized residues of:
(1) about 20 to 60%, based on the total weight of (1), (2), and (3), of an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer other than methacrylic acid or acrylic acid;
wherein the acetoacetate residues are neutralized or reacted with a base selected from alkali metal hydroxides, ammonia and amines.

13. A polymer according to claim 10 having a glass transition temperature of about 50 to 100° C. and comprising polymerized residues of:
(1) about 20 to 60%, based on the total weight of (1), (2), and (3), of 2-acetoxyethyl methacrylate;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer selected from methyl methacrylate, styrene, n-butyl acrylate, and 2-ethylhexyl acrylate;
wherein the acetoacetate residues are neutralized or reacted with a base selected from alkali metal hydroxides, ammonia and amines.

14. A gas filter device according to claim 1 comprising as the filter medium an unsupported, particulate acetoacetate-functional acrylic polymer having a glass transition temperature greater than about 40° C. wherein the acetoacetate residues are neutralized or reacted with a base.

15. A gas filter device according to claim 1 comprising as the filter medium an unsupported, particulate acetoacetate-functional acrylic polymer having a glass transition temperature of about 40 to 100° C. and comprising polymerized residues of:
(1) about 10 to 80 weight percent of residues of 2-acetoacetoxyethyl acrylate, 2-cetoacetoxyethyl methacrylate, 2-acetoacetoxypropyl methacrylate, 2-cetoacetoxypropyl acrylate, or a mixture of any two or more thereof; and
(2) about 20 to 90 weight percent of residues of methyl methacrylate, butyl acrylate, styrene, 2-ethylhexyl acrylate, methacrylic acid, acrylic acid, or a mixture of any two or more thereof; wherein the weight percentages are based on the total weight of the AcAc polymer;
wherein the acetoacetate residues are neutralized or reacted with a base selected from alkali metal hydroxides, ammonia and amines.

16. A gas filter device according to claim 1 comprising as the filter medium an unsupported, particulate acetoacetate-functional acrylic polymer having a glass transition temperature of about 50 to 100° C. and comprising polymerized residues of:
(1) about 20 to 60%, based on the total weight of (1), (2), and (3), of an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer other than methacrylic acid or acrylic acid;
wherein the acetoacetate residues are neutralized or reacted with a base selected from alkali metal hydroxides, ammonia and amines.

17. A gas filter device according to claim 1 comprising as the filter medium an unsupported, particulate acetoacetate-functional acrylic polymer having a glass transition temperature of about 50 to 100° C. and comprising polymerized residues of:
(1) about 20 to 60%, based on the total weight of (1), (2), and (3), of 2-acetoxyethyl methacrylate;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer selected from methyl methacrylate, styrene, n-butyl acrylate, and 2-ethylhexyl acrylate;
wherein the acetoacetate residues are neutralized or reacted with a base selected from alkali metal hydroxides, ammonia and amines.

18. A gas filter device comprising as the filter medium a particulate or finely-divided acetoacetate-functional compound or composition and a metallic oxidizing agent or oxidation catalyst.

19. A gas filter device according to claim 1 comprising a filter bed, filter cartridfge or tobacco smoke filter containing as the filter medium an unsupported, particulate or finely-divided acetoacetate-functional compound or composition selected from small molecules, oligomers and polymers containing acetoacetate residues and a metallic oxidizing agent or oxidation catalyst selected from compounds of Cu(II), Mn(IV), Fe(III), Sn(IV), Co(II), Co(III), Zr(II), Ca(II), VO(II), Al(III), and Cr(III).

20. A gas filter device according to claim 1 comprising as the filter medium an unsupported, particulate acetoacetate-functional polymer selected from polyesters, polyacrylates, acrylics, polyethers, polyurethanes, polyolefins, polyvinyl alcohols, polysiloxanes, and cellulose esters and a metallic oxidizing agent or oxidation catalyst selected from compounds of Cu(II), Mn(IV), Fe(III), Sn(IV), Co(II), Co(III), Zr(II), Ca(II), VO(II), Al(III), and Cr(III).

21. A gas filter device according to claim 1 comprising as the filter medium an unsupported, particulate acetoacetate-functional acrylic polymer having a glass transition temperature greater than about 40° C. and a metallic oxidizing agent or oxidation catalyst.

22. A gas filter device according to claim 1 comprising as the filter medium an unsupported, particulate acetoacetate-functional acrylic polymer having a glass transition temperature of about 40 to 100° C. and comprising polymerized residues of:
(1) about 10 to 80 weight percent of residues of 2-acetoacetoxyethyl acrylate, 2-cetoacetoxyethyl methacrylate, 2-acetoacetoxypropyl methacrylate, 2-cetoacetoxypropyl acrylate, or a mixture of any two or more thereof; and
(2) about 20 to 90 weight percent of residues of methyl methacrylate, butyl acrylate, styrene, 2-ethylhexyl acrylate, methacrylic acid, acrylic acid, or a mixture of any two or more thereof; wherein the weight percentages are based on the total weight of the AcAc polymer; and
a metallic oxidizing agent or oxidation catalyst selected from compounds of Cu(II), Mn(IV), Fe(III), Sn(IV), Co(II), Co(III), Zr(II), Ca(II), VO(II), Al(III), and Cr(III).

23. A gas filter device according to claim 1 comprising as the filter medium an unsupported, particulate acetoacetate-functional acrylic polymer having a glass transition temperature of about 50 to 100° C. and comprising polymerized residues of:
(1) about 20 to 60%, based on the total weight of (1), (2), and (3), of an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3); of an ethylenically unsaturated monomer other than methacrylic acid or acrylic acid; and
a metallic oxidizing agent or oxidation catalyst selected from compounds of Cu(II), Mn(IV), Fe(III), Sn(IV), Co(II), Co(III), Zr(II), Ca(II), VO(II), Al(III), and Cr(III).

24. A gas filter device according to claim 1 comprising as the filter medium an unsupported, particulate acetoacetate-functional acrylic polymer having a glass transition temperature of about 50 to 100° C. and comprising polymerized residues of:
(1) about 20 to 60%, based on the total weight of (1), (2), and (3), of 2-acetoxyethyl methacrylate;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer selected from methyl methacrylate, styrene, n-butyl acrylate, and 2-ethylhexyl acrylate; and
a metallic oxidizing agent or oxidation catalyst selected from compounds of Cu(II), Mn(IV), Fe(III), Sn(IV), Co(II), Co(III), Zr(II), Ca(II), VO(II), Al(III), and Cr(III).

25. A method for the removal of a gaseous aldehyde from a gas which comprises contacting a gas containing a gaseous aldehyde with a filter medium comprising a particulate or finely-divided acetoacetate-functional compound or composition.

26. The method of claim 25 wherein the filter medium comprises a particulate or finely-divided acetoacetate-functional small molecule, oligomer or polymer composition containing acetoacetate residues.

27. The method of claim 25 for the removal formaldehyde from a gas which comprises contacting a gas containing formaldehyde with a filter medium comprising a dry, particulate or finely-divided acetoacetate-functional compound or composition.

28. The method of claim 25 wherein the filter medium comprises an unsupported, particulate acetoacetate-functional polymer selected from polyesters, polyacrylates, acrylics, polyethers, polyurethanes, polyolefins, polyvinyl alcohols, polysiloxanes, and cellulose esters.

29. The method of claim 25 wherein the filter medium comprises an unsupported, particulate acetoacetate-functional acrylic polymer having a glass transition temperature greater than about 40° C.

30. A method for the removal of formaldehyde from a gas which comprises contacting a gas containing formaldehyde with a filter medium comprising an unsupported, particulate acetoacetate-functional acrylic polymer having a glass transition temperature of about 40 to 100° C. and comprising polymerized residues of:
(1) about 10 to 80 weight percent of residues of 2-acetoacetoxyethyl acrylate, 2-cetoacetoxyethyl methacrylate, 2-acetoacetoxypropyl methacrylate, 2-cetoacetoxypropyl acrylate, or a mixture of any two or more thereof; and
(2) about 20 to 90 weight percent of residues of methyl methacrylate, butyl acrylate, styrene, 2-ethylhexyl acrylate, methacrylic acid, acrylic acid, or a mixture of any two or more thereof; wherein the weight percentages are based on the total weight of the AcAc polymer.

31. A method for the removal of formaldehyde from air which comprises contacting air containing formaldehyde with a gas filter device comprising a filter bed, filter cartridge or tobacco smoke filter containing as the filter medium the unsupported, particulate or finely-divided acetoacetate-functional polymer of claim 30.

32. A method according to claim 30 wherein the filter medium is an unsupported, particulate acetoacetate-functional acrylic polymer having a glass transition temperature of about 50 to 100° C. and comprising polymerized residues of:
(1) about 20 to 60%, based on the total weight of (1), (2), and (3), of an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer other than methacrylic acid or acrylic acid.

33. A method for the removal of formaldehyde from air which comprises contacting air containing formaldehyde with a gas filter device comprising a filter bed, filter cartridge or tobacco smoke filter containing as the filter medium the unsupported, particulate or finely-divided acetoacetate-functional polymer of claim 32.

34. A method according to claim 32 wherein the filter medium is an unsupported, particulate acetoacetate-functional acrylic polymer having a glass transition temperature of about 50 to 100° C. and comprising polymerized residues of:
(1) about 20 to 60%, based on the total weight of (1), (2), and (3), of 2-acetoxyethyl methacrylate;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer selected from methyl methacrylate, styrene, n-butyl acrylate, and 2-ethylhexyl acrylate.

35. A method for the removal of formaldehyde from air which comprises contacting air containing formaldehyde with a gas filter device comprising a filter bed, filter cartridge or tobacco smoke filter containing as the filter medium the unsupported, particulate or finely-divided acetoacetate-functional polymer of claim 34.

36. A dry, porous, particulate, acetoacetate-functional acrylic polymer having a glass transition temperature greater than about 40° C. containing voids, cavities, channels or a combination thereof.

37. A dry, porous, particulate, base-neutralized polymer according to claim 36 having a glass transition temperature of about 40 to 100° C. containing voids, cavities, channels or a combination thereof and comprising polymerized residues of:
(1) about 10 to 80 weight percent of residues of 2-acetoacetoxyethyl acrylate, 2-toacetoxyethyl methacrylate, 2-acetoacetoxypropyl methacrylate, 2-cetoacetoxypropyl acrylate, or a mixture of any two or more thereof; and
(2) about 20 to 90 weight percent of residues of methyl methacrylate, butyl acrylate, styrene, 2-ethylhexyl acrylate, methacrylic acid, acrylic acid or a mixture of any two or more thereof; wherein the weight percentages are based on the total weight of the AcAc polymer.

38. A dry, porous, particulate, polymer according to claim 36 having a glass transition temperature of about 50 to 100° C. containing voids, cavities, channels or a combination thereof and comprising polymerized residues of:
(1) about 20 to 60%, based on the total weight of (1), (2), and (3), of an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer other than methacrylic acid or acrylic acid.

39. A dry, porous, particulate, polymer according to claim 36 having a glass transition temperature of about 50 to 100° C. containing voids, cavities, channels or a combination thereof and comprising polymerized residues of:
(1) about 20 to 60%, based on the total weight of (1), (2), and (3), of 2-acetoxyethyl methacrylate;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer selected from methyl methacrylate, styrene, n-butyl acrylate, and 2-ethylhexyl acrylate.

40. A gas filter device according to claim 1 comprising as the filter medium a dry, unsupported, porous, particulate acetoacetate-functional acrylic polymer having a glass transition temperature greater than about 40° C. containing voids, cavities, channels or a combination thereof.

41. A gas filter device according to claim 1 comprising as the filter medium a dry, unsupported, porous, particulate acetoacetate-functional acrylic polymer having a glass transition temperature of about 40 to 100° C. containing voids, cavities, channels or a combination thereof and comprising polymerized residues of:
(1) about 10 to 80 weight percent of residues of 2-acetoacetoxyethyl acrylate, 2-acetoacetoxyethyl methacrylate, 2-acetoacetoxypropyl methacrylate, 2-acetoacetoxypropyl acrylate, or a mixture if any two or more thereof; and
(2) about 20 to 90 weight percent of residues of methyl methacrylate, butyl acrylate, styrene, 2-ethylhexyl acrylate, methacrylic acid, acrylic acid or a mixture of any two or more thereof; wherein the weight percentages are based on the total weight of the AcAc polymer.

42. A gas filter device according to claim 1 comprising as the filter medium a dry, unsupported, porous, particulate acetoacetate-functional acrylic polymer having a glass transition temperature of about 50 to 100° C. containing voids, cavities, channels or a combination thereof and comprising polymerized residues of:
(1) about 20 to 60%, based on the total weight of (1), (2), and (3), of an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer other than methacrylic acid or acrylic acid.

43. A gas filter device according to claim 1 comprising as the filter medium a dry, unsupported, porous, particulate acetoacetate-functional acrylic polymer having a glass transition temperature of about 50 to 100° C. containing voids, cavities, channels or a combination thereof and comprising polymerized residues of:
(1) about 20 to 60%, based on the total weight of (1), (2), and (3), of 2-acetoxyethyl methacrylate;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer selected from methyl methacrylate, styrene, n-butyl acrylate, and 2-ethylhexyl acrylate.

44. The method of claim 25 wherein the filter medium comprises a dry, unsupported; porous, particulate acetoacetate-functional acrylic polymer having a glass transition temperature greater than about 40° C. containing voids, cavities, channels or a combination thereof.

45. The method of claim 25 wherein formaldehyde is removed from a gas which comprises contacting a gas containing formaldehyde with a filter medium comprising a dry, unsupported, porous, particulate acetoacetate-functional acrylic polymer having a glass transition temperature of about 40 to 100° C. containing voids, cavities, channels or a combination thereof and comprising polymerized residues of:
(1) about 10 to 80 weight percent of residues of 2-acetoacetoxyethyl acrylate, 2-acetoacetoxyethyl methacrylate, 2-acetoacetoxypropyl methacrylate, 2-acetoacetoxypropyl acrylate, or a mixture if any two or more thereof; and
(2) about 20 to 90 weight percent of residues of methyl methacrylate, butyl acrylate, styrene, 2-ethylhexyl acrylate, methacrylic acid, acrylic acid or a mixture of any two or more thereof; wherein the weight percentages are based on the total weight of the AcAc polymer.

46. A method according to claim 45 wherein the filter medium is a dry, unsupported, porous, particulate acetoacetate-functional acrylic polymer having a glass transition temperature of about 50 to 100° C. containing voids, cavities, channels or a combination thereof and comprising polymerized residues of:
(1) about 20 to 60%, based on the total weight of (1), (2), and (3), of an ethylenically unsaturated monomer selected from 2-acetoxyethyl acrylate, 2-acetoxyethyl methacrylate, 2-acetoxypropyl acrylate, 2-acetoxypropyl methacrylate and a mixture of any two or more thereof;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer other than methacrylic acid or acrylic acid.

47. A method according to claim 45 wherein the filter medium is a dry, unsupported, porous, particulate acetoacetate-functional acrylic polymer having a glass transition temperature of about 50 to 100° C. containing voids, cavities, channels or a combination thereof and comprising polymerized residues of:
(1) about 20 to 60%, based on the total weight of (1), (2), and (3), of 2-acetoxyethyl methacrylate;
(2) about 4 to 10%, based on the total weight of (1), (2), and (3), of methacrylic acid, acrylic acid, or a mixture thereof; and
(3) about 30 to 76%, based on the total weight of (1), (2), and (3), of an ethylenically unsaturated monomer selected from methyl methacrylate, styrene, n-butyl acrylate, and 2-ethylhexyl acrylate.
